(19) United States
(12) Patent Application Publication
(10) Pub. No.: US 2012/0110791 A1
(43) Pub. Date: May 10, 2012

(54) WIRE ETC. CONNECTORS

(76) Inventor: Lee Mark Giemza, Sheffield (GB)

(21) Appl. No.: 13/322,112

(22) PCT Filed: Jul. 7, 2010
(86) PCT No.: PCT/GB10/01299

§ 371 Date: Nov. 22, 2011

(30) Foreign Application Priority Data
Jul. 9, 2009 (GB) 0911873.8
Sep. 18, 2009 (GB) 0916373.4

(51) Int. Cl. F16G 11/04; F16G 11/00

(52) U.S. Cl. 24/136 R

(57) ABSTRACT

The invention relates to locking device for wire and has for a first objective the prevention of accidental release of the wire, and for a second objective, the ability to accommodate several diameters of wire. The first objective is met be a locking device comprising an annular protrusion to one end of the locking device secured to a guideway of the slide, the annular protrusion having an angled exposed end to provide an apex lying above and overlapping the edge of the adjacent slide or push-button and the second objection by a device comprising a body, two channels within the body, entry ends at opposite ends for wires, and wedging means within the body spring-urged towards the entry ends and to protrude into the channels for the purpose of gripping inserted wires and preventing their withdrawal and slides or push-buttons being fitted one within each of the guideways outer end protruding outwards beyond the entry end of the channel allowing inward sliding to push the wedging means against a springurge, the slide or push-button and the wedging means being secured together.

This invention relates to connectors or locking devices for wires, wire ropes or cables (hereinafter referred to simply as “wires”) of the type having a body, at least one channel within the body, entry ends at opposite ends for wires, and wedging means within the body spring-urged towards the entry ends and protruding into the at least one channel for the purpose of gripping inserted wires and preventing their withdrawal in the opposite direction to insertion. The wedging means may consist of rollers, cams or wedges, usually provided with ribs to enhance their grip.

It is also known to provide such a connector with means for withdrawing the wedging means from the at least one channel to release either or both wires, which withdrawing means comprises pins extending laterally from the wedging means through slots in opposite sides or one side only of the body, with or without knobs on the outside to facilitate sliding of the pins along the slots; see, for example, U.S. Pat. No. 2,387,436 (Frank), GB-A-1 217 911 (Pasbrig) and U.S. Pat. No. 3,927,441 (Anzini) or the Zip-Clip® device marketed by Zip-Clip Ltd. A disadvantage of these withdrawing means is that the slots in the side or sides of the body weaken it.

It is also known to form the body of such a connector or locking device with two channels extending therethrough in back-to-back relationship with a thin wall between them and with small holes alongside the entry ends of the channels for insertion of a separate rod-like tool to push either of the wedging means against its spring urge to effect release of the respective inserted wire; see, for example, WO-A-95/30844 and WO-A-03/019040. It is a disadvantage of this form of release means that the body of the connector has to be held in one hand while the other hand inserts the rod-like tool into one or other of the small holes and therefore not leaving a hand free to withdraw or adjust the position of the released wire. Another disadvantage lies in having a separate release tool that can be lost or mislaid.

Those disadvantages mentioned above have been dealt with successfully by the connector or locking device described and claimed in PCT/GB2009/000580 where the connector or locking device for wires has a body, two channels within the body, entry ends at opposite ends for wires, and wedging means within the body spring-urged towards the entry ends and to protrude into the channels for the purpose of gripping inserted wires and preventing their withdrawal in the opposite direction to insertion, and which is characterised in that guideways are formed within the body at least one alongside each channel from adjacent its entry end to beyond its wedging means, and slides are fitted one within each of the guideways each with its inner end overlapping part of the respective wedging means and its outer end protruding outwards beyond the entry end of the channel, retention means being provided between each slide and its guideway to retain the slide within its guideway while allowing inward sliding to push the wedging means against its spring-urge when the outer end of the slide is pushed relative to the body.

Thus, a wire can be inserted one into the entry end of either channel (or both) alongside the respective slide until the leading wire end meets the non-overlapped portion of the respective wedging means and pushes it against its spring-urge until the wire end passes beyond the wedging means, whereafter it can be gripped between the latter and the channel.

When it is required that the wire be released, for withdrawal from or adjustment of its position relative to the body, the outer end of the respective slide can be pushed by the thumb or a finger of a hand gripping the body until the inner end of the slide meets the respective wedging means and pushes it against its spring-urge until the wire is free and can be withdrawn or its position altered by the other hand.

Furthermore, when a pair of wires connected by the device are both to be released both slides can be pushed relative to the body by pressing their outer ends, one by the thumb and the other by a finger of one hand, leaving the other hand free to withdraw or adjust the wires, or one wire, or to move the device lengthwise relative to one wire looped back through the device, e.g. in the manner described in WO-A-03/019040.

Each retention means may comprise a first projection on the guideway side of the slide and a second projection in the guideway, with flexibility in the slide or the first projection and appropriate bevelling of the first projection enabling it to snap over the second projection as the slide is inserted in the guideway during assembly of the connector or locking device.

While the channels may be disposed end-to-end or side-by-side they are preferably disposed back-to-back in close lengthwise relationship with each other and separated by a wall portion which may be capable of localised distortion to increase frictional contact with inserted wires under the urge of the wedging means.

The body may be formed of an alloy e.g. zinc alloy, by die-casting, and the slides may be formed of plastics; and each slide may be provided at its outer end with an enlargement, e.g. a substantially circular button.

When no wires have been inserted into the channels, each slide could protrude from the respective entry end of the respective channel by at least the available length of travel of the respective wedging means by spring urge, limited only by the first projection coming into abutment with the second projection to prevent withdrawal of the slide from the body, and so the portions of the slides protruding from the body make them vulnerable during assembly, transport and on-site before insertion of wires.

Therefore at least a third projection is preferably provided on the guideway side of each slide, of lesser prominence than the first projection but capable of snapping over the respective second projection in succession to the first projection, thereby positioning the respective wedging means close to where it would be when preventing withdrawal of an inserted wire.

Thus the respective slide will protrude from the body by a lesser extent equal to the spacing of the first and third projections, and so will be less vulnerable. In addition, it will be easier for an inserted wire to push past the respective wedging means because the latter protrudes into the respective channel to a lesser extent and does not have to be pushed as far by the wire against the spring urge as it would in the absence of the third projection.

However, the reason for the lesser prominence of the third projection is to enable it to snap back over the second projection in the event of an inserted wire or wires becoming overloaded, thereby causing the wedging means to move further down to resist the increased load when the consequently increased protrusion of the slide from the body gives a visual indication of the overloading.

Further additional lesser projections may be provided to yield to a progressive overload, with resultant progressive further protrusion of the slide from the body giving visual indication of its progression.

Preferably, at least first and third projections are provided on each of two opposite faces of the slide to cooperate with respective second projections on corresponding sides of the guideway, thus resulting in a balanced loading between respective second and third projections.

Plastics caps are preferably snap-fitted one into each end of the body to retain a respective compression spring for urging the respective wedging means into the respective channel.

When used in the manner prescribed, the connector or locking device of PCT/GB2009/000580 is most effective, but if there is misuse, there are circumstances where the connector or locking device can be caused to disconnect or temporarily unlock.

In one usage, one end of a length of wire can be passed through a connector or locking device, and the emerging end secured to a support, the free end being looped around an object to be suspended from the support and inserted through the connector, with the intent that the object is lifted to its required height, and the free end of the wire pulled through the connector until the loop is at the height at which the object is to be suspended. Operatives are instructed not to use the wire and connector as a hoist by pulling on the free end of the wire to shorten the loop and lift the object to its required height, but if they should ignore that advice, the possibility arises that the free end of the wire can overlie the outer protruding end of the slide, a downwardly directed force on the free end of the wire could then act on the slide, to urge it inwardly and push its wedging means against its spring, to prevent gripping of the wire whilst the free end is being pulled. When the free end is released the wedging means again grips the wire, but not necessarily at the desired position.

The object of the present invention is to overcome this problem in connectors or locking devices as are described in PCT/GB2009/000580, and with other wire connection locking devices where a disconnection from its wire is brought about by the depression of a slide or a push-button, such that in the event that the connector or locking device is not used in a prescribed manner, accidental disconnection of the connecting or locking device is avoided.

According to a first aspect of the present invention, a connector or locking device for wire of the type incorporating a slide or push-button to disconnect the device from a wire, comprises an annular protrusion to one end of the connector or locking device secured to a guideway of the slide for wire at that end, to form an inlet for wire extending through the connector or locking device, the annular protrusion having an angled exposed end to provide an apex lying above and overlapping the edge of the adjacent slide or push-button, and side edges that slope downwardly to both sides of the apex.

Thus, wire extending through the connector from the inlet and emerging from the connector or locking device through an exit formed at the opposite end by the annular protrusion, which if improperly or accidently pulled to a position where it overlies the slide or push-button, is caused to contact the end of the annular protrusion, and a further loading of the wire causes it to slide down one or other of the side edges of the protrusion, to a location to one side or the other of the slide, and hence is effectively prevented from pressing on the slide or push-button to cause a movement of its wedge that would otherwise cause the connector to disconnect. The protrusion may be separately formed and suitably attached to the connector to surround the wire inlet to the connector, but preferably the protrusion is formed as an annulus integrally with a guide within the connector for the passage of wire, to emerge from the connector and have its apex overlying the edge of an adjacent slide or push-button.

Preferably, the wedge is spring-loaded in a direction towards the inlet to the connector or locking device, such as by a compression spring.

In the circumstance where a connector has a slide or push-button at each end, an annular protrusion may be provided at each end, in association with the respective slide or push-button.

The connector or locking device described and claimed in PCT/GB2009/000580 is ordinarily designed to suit a particular wire diameter, albeit that different wire diameters within acceptable manufacturing tolerances can be held successfully by the connector or locking device.

There can, however, be circumstances where it would be desirable for one size of connector or locking device to be able to accept two different wire diameters. There is no essential difficulty in having a wedging means able to contact and hold fast wires of a larger and of a smaller diameter. However, the length required for a slide and the position of the retention means between the slide and the guideway must be such that the wedge urged by its spring is not prevented from reaching its position where a maximum locking force is applied to the wire of a smaller diameter.

There is then the problem that with a wire of a larger diameter, the wedging means is urged inwardly to a greater degree, and its position where it exerts a maximum locking action on a wire is distanced from the position occupied by the wedging means gripping a wire of a smaller diameter. With a wire of a smaller diameter the slide is held in its position of rest by the wedging means but with a wire of a larger diameter it is not and the slide is free to move from a position where it contacts the retention means to a position where the end of the slide makes contact with the wedging means.

A further object of the invention is to provide a connector or locking device that avoids the above mentioned disadvantages.

According to a further aspect of the present invention, a connector or locking device comprises a body, two channels within the body, entry ends at opposite ends for wires, and wedging means within the body spring-urged towards the entry ends and to protrude into the channels for the purpose of gripping inserted wires and preventing their withdrawal in the opposite direction to insertion, guideways being formed within the body at least one alongside each channel from adjacent its entry end to beyond its wedging means, and slides or push-buttons being fitted one within each of the guideways each with its inner end abutting part of the respective wedging means and its outer end protruding outwards beyond the entry end of the channel, retention means being provided between each slide or push-button and its guideway to retain the slide or push-button within its guideway while allowing inward sliding to push the wedging means against a spring-urge when the outer end of the slide or push-button is pushed relative to the body, the slide or push-button and the wedging means being secured together. To ensure that the wire can be inserted through the connector or locking device, it is preferred that the wedging means are on an inclined slideway, such that when the wedging means is moved longitudinally either by the insertion of wire, or by the slide to release the wire, its movement is in a plane at an angle to the axis of the channels (and hence the wire), to cause the wedging mean to move laterally away from and towards the wire.

Thus, it is preferred that the connection between the slide or push-button and the wedging means permits articulation between them during movement of the wedging means and slide or push-button. The connection may be formed by a flexible integral extension on the slide or push-button suitably attached to the adjacent end of the wedging means by such as adhesive or welding. Alternatively a separately formed and flexible spring-like member may be provided suitably secured to the end of the slide or push-button and the adjacent end of the wedging means.

Such constructions require the slide and attached wedging means to be positioned in the connector or locking means during its assembly.

To enable the connector to be assembled with its slide or push-button, and the wedging means subsequently fitted, spring clip means with opposed fingers may be provided on the slide or push-button to clip behind co-operating formations on the adjacent end of the wedging means. Thus, with the connector or locking device assembled with its slides, the wedging means can be pushed into the respective guideway into contact with the opposed fingers of the spring clip means on the slide, and a snap-fit connection created between the spring clip means and the formations on the wedging means, whereby to provide a connection between the slide and the wedging means and allow required articulation between the wedging means and the slide. The spring for the wedging means can then be inserted behind the wedging means in its channel, and the channel closed by a cap against which the spring can be compressed.

It would however be possible to assemble the body with its wedging means and spring, and to insert the slide into the respective guideway with the opposed fingers of the spring clip means positioned to either side of the wedging means and a snap-fit connection created between the spring clip means and the formations on the wedging means.

Two embodiments of the invention are illustrated in the accompanying drawings, in which:

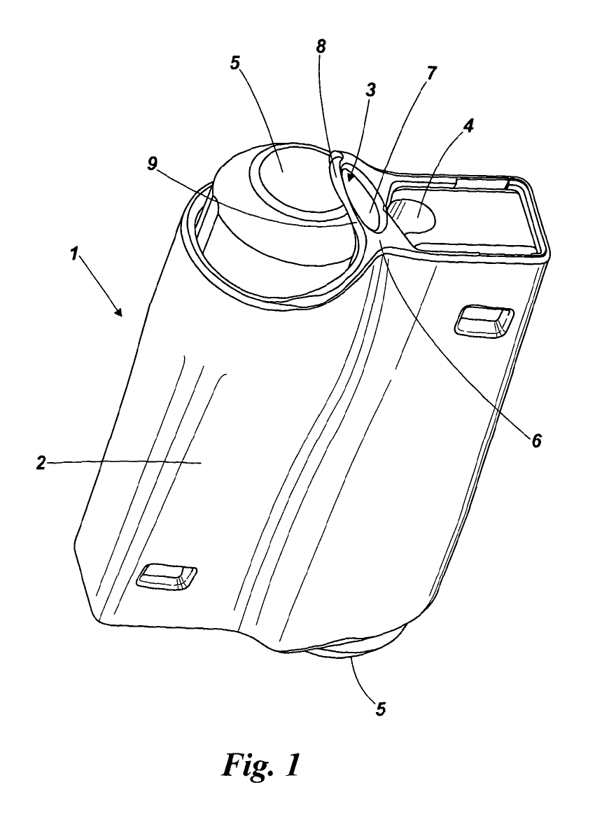

FIG. 1 is a perspective view of a first embodiment of connector in accordance with the invention, from above and one side;

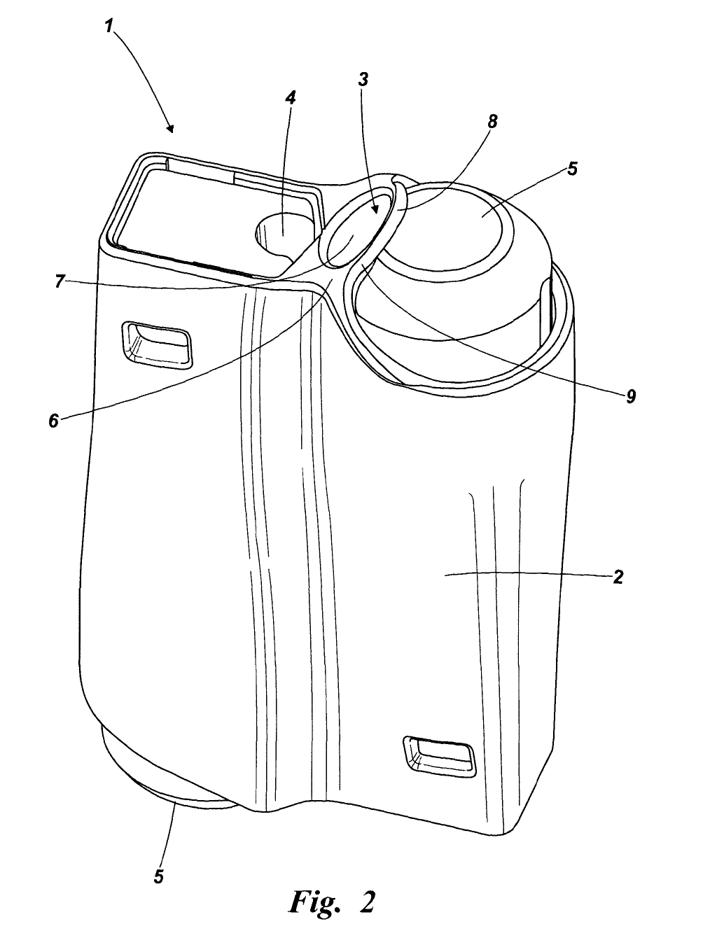

FIG. 2 corresponds to FIG. 1 but is a perspective view from above and from the opposite side;

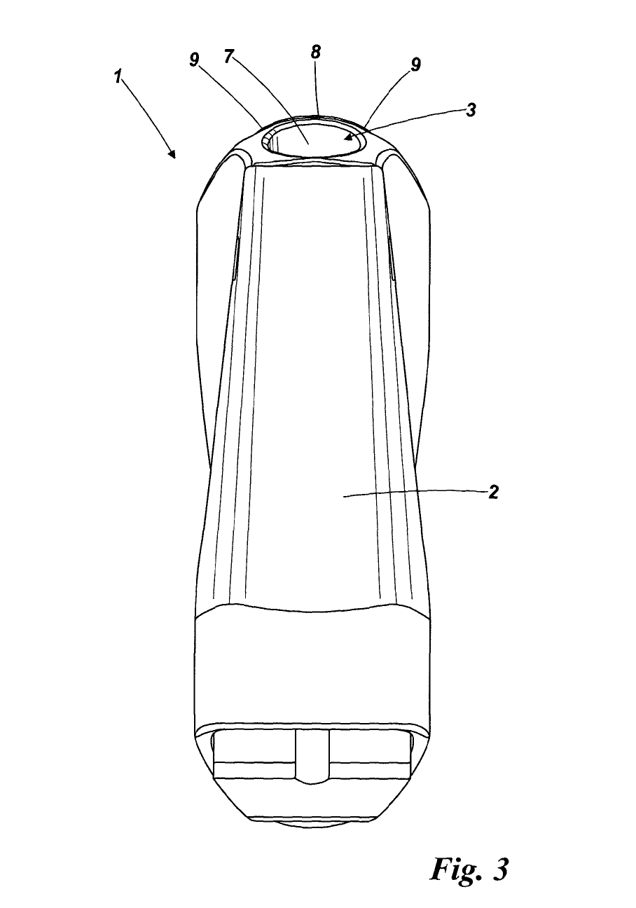

FIG. 3 is an elevation of the connector of FIG. 1 from one side;

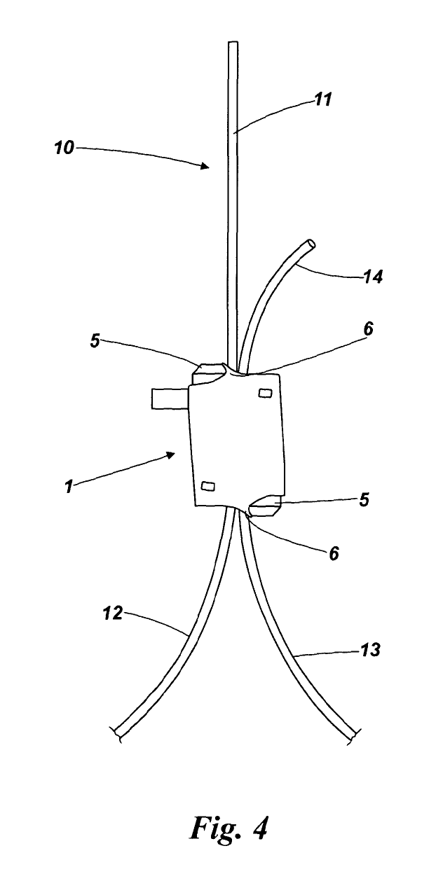

FIGS. 4 to 6 show the connector of FIG. 1 used as a suspension device;

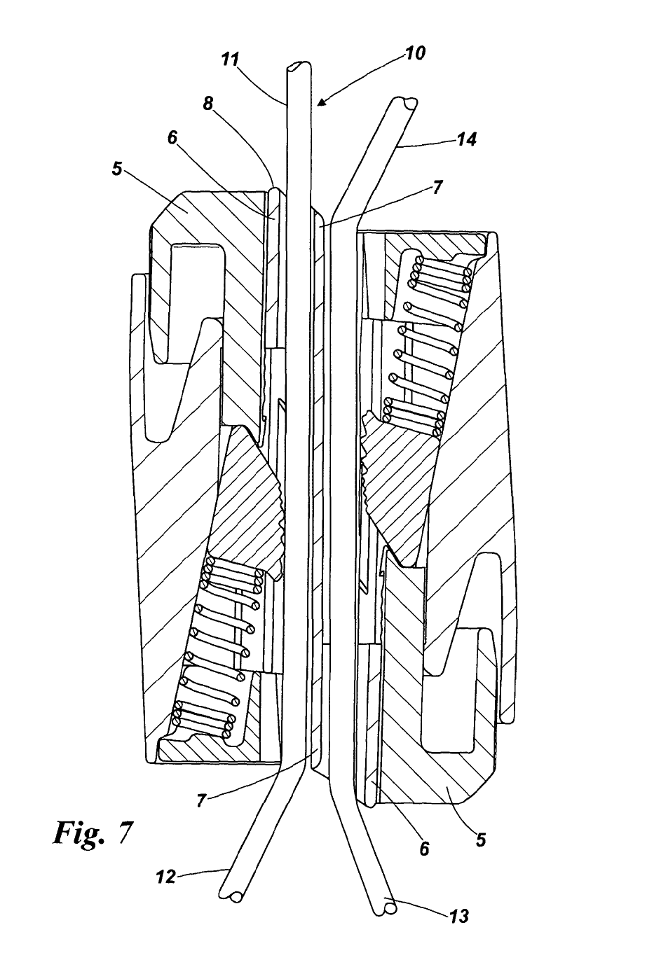

FIG. 7 is a sectional front elevation of the connector of FIG. 1;

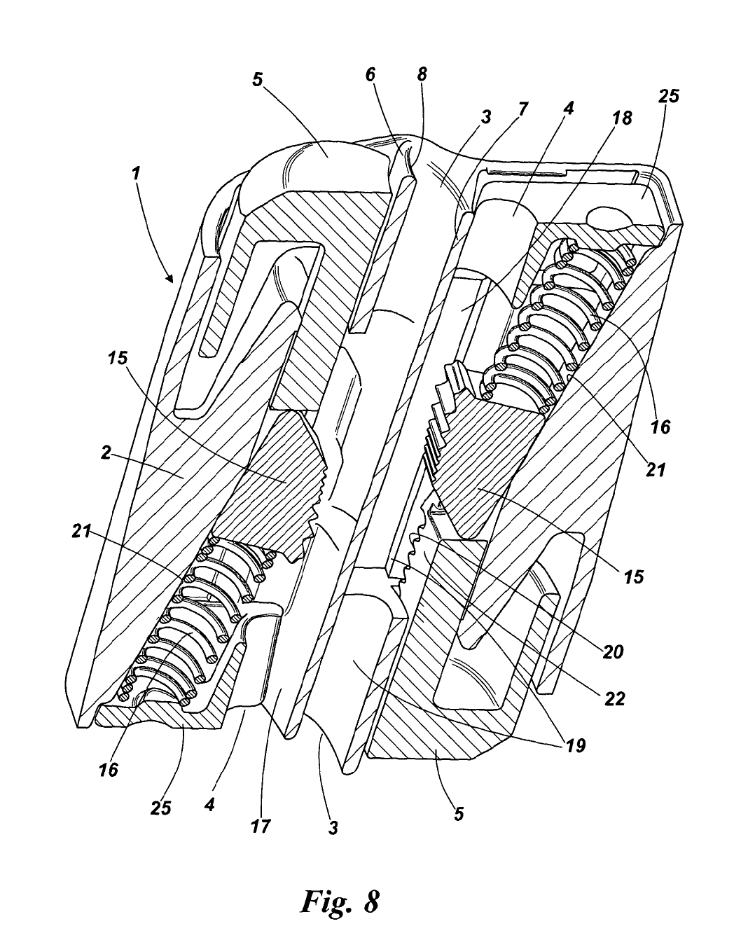

FIG. 8 is a sectional perspective view of a second embodiment of connector or locking device in accordance with the invention;

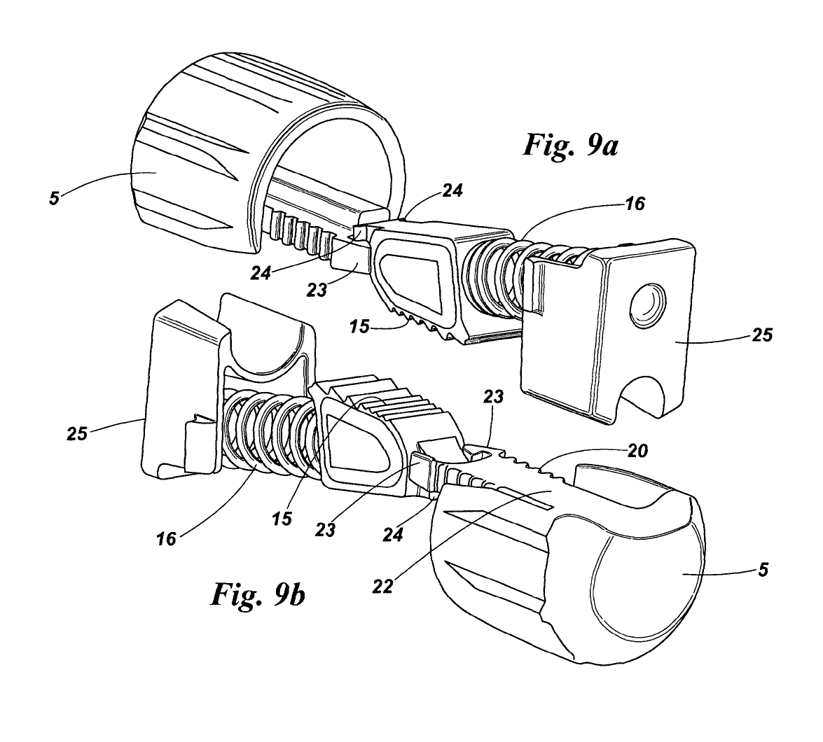

FIGS. 9a and 9b are, respectively, perspective views of the slides and associated wedging means of FIG. 8; and

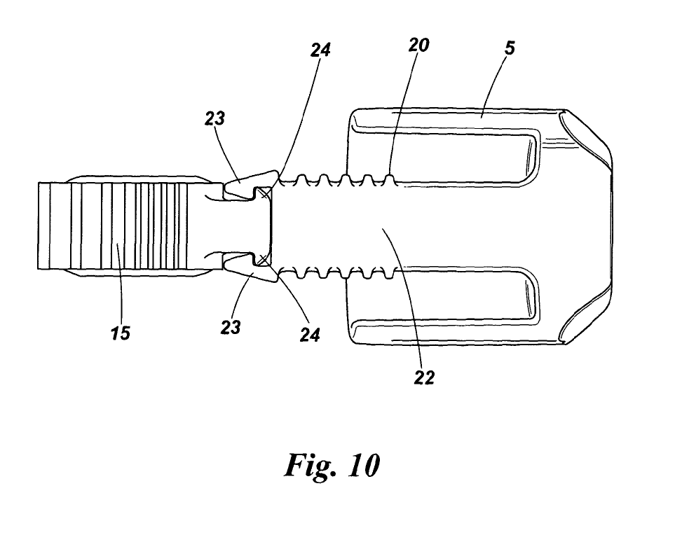

FIG. 10 is a plan view of one slide and its associated wedging means of FIG. 8.

In FIGS. 1 to 7, a connector or locking device 1 has a body 2 with an inlet 3 for one channel and exit 4 for the other channel, for wire at each end, and an operating slide or push-button 5 at each end to operate mechanism within the body and allow the passage of lengths of wire through the body until the connector or locking device is positioned as required, following which release of the slide or push-buttons 5 allows the mechanism with the body to lock on the wire extending through the body.

Surrounding the inlet 3 at each end of the body is an annular protrusion 6, formed integral with a respective wire guide 7 within the casing, the protrusion being angled to overlie the adjacent edge of the slide or push-button 5, and the protrusion having an apex 8 set higher than the top of the slide or push-button, and sloping edges 9 extending down to the wire guide 7.

As is illustrated in FIGS. 4 to 6, the connector or locking device 1 can be used to create a loop from the wire to which it is connected. Thus, and as is shown in FIG. 4, a wire length 10 has a first section 11 extending through the casing, the emerging length 12 being formed into a loop, and the return section 13 extending through the casing and emerging as a free end 14. When used in accordance with advised practices, the wire section 11 may be secured in an elevated position, and the wire passed through the casing looped around an object to be suspended, and the object lifted to the required height. The free end 14 of the wire can be pulled upwards to tighten the loop around the object at its required height.

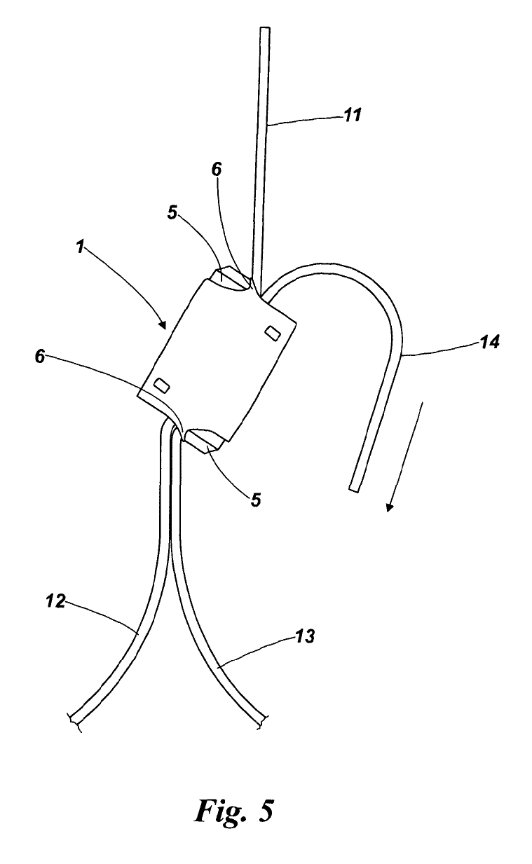

However, if the connector or locking device is misused, the connector or locking device attempted to be used as a hoist, a downward pull as is indicated in FIG. 5 to shorten the loop causes the connector or locking device to pivot, but instead of the wire length 11 bearing on and depressing the slide or push-button 5 at that end of the casing, it contacts the apex 8 of the protrusion 6, and further pivoting of the connector or locking device causes the wire to ride down the sloping edges of the protrusion, effectively preventing the slide or push-button 5 from being depressed, and ensuring that the connector or locking device is not released from the wire. Similarly, and at the opposite end of the connector or locking device, rocking of it by a downward pull on the wire length 14, brings the wire length 13 into proximity with the slide or push-button 5 at that end, but which is prevented from contacting and depressing the slide or push-button by the protrusion 6 at that end.

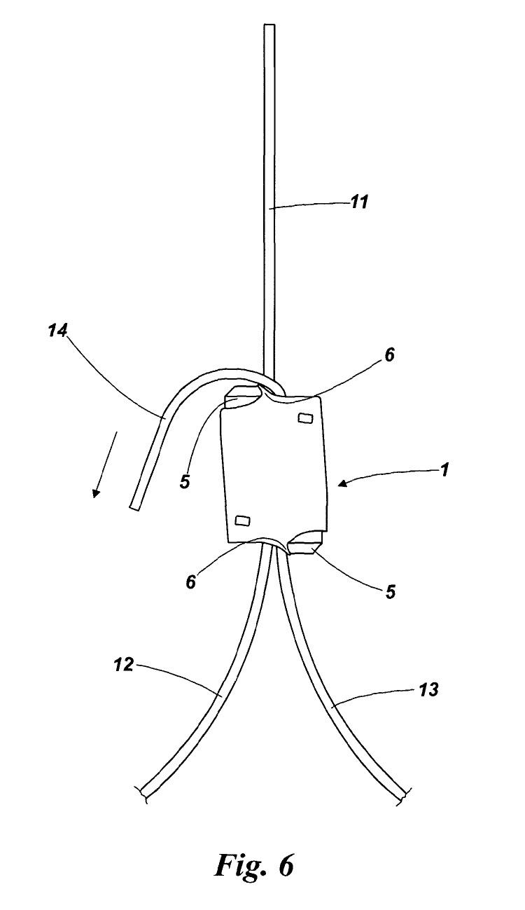

Similarly if, and as is shown in FIG. 6, the free end 14 of the wire is pulled across the connector or locking device, and a downward force applied, the apex 8 of the protrusion 6 prevents the wire from contacting the slide or push-button 5, the wire is caused to ride down the sloping edges 9 of the protrusion, and again, depression of the slide or push-button is prevented.

FIG. 7 is a sectional side elevation of a connector or locking device with locking mechanism in accordance with PCT/GB2009/000580, which needs no further description here. The connector or locking device is provided with the annular protrusion 6 at each end, in close spaced relation to the slide 5, the apex 8 of the protrusion extending above the slide. The wire length 10 has its first section 11 extending through the casing, with the emerging length 12 formed into a loop with its return section 13 extending through the casing to emerge as a free end 14.

This novel adaptation of the connector or locking device of PCT/GB2009/000580 ensures that all of the benefits of that construction are retained when used to create a suspension loop, and eliminated is the possibility of unintended and unrequired unlocking of the connector or locking device from the wire if the connector or locking device is attempted to be used as a hoist.

In the embodiment illustrated in FIGS. 8 to 10, like parts are given the reference numerals employed in FIGS. 1 to 7. Thus, a connector or locking device 1 has a body or housing 2 with an inlet 3 for one channel and an exit 4 for the other channel, for wire at each end, and an operating slide or push-button 5 at each end to operate a mechanism within the body 2 and allow the passage of lengths of wire through the body until the connector or locking device is positioned as required, following which the release of the slide or push-button 5 allows the mechanism within the body to lock on to the wires extending through the body.

The mechanism within the body is formed by wedging means 15 to which the slides or push buttons 5 extend, and there being to the opposite side of the slides or push buttons, springs 16 to urge the wedges towards the entry end of each wire channel 17, 18 and to grip on wires extending through the channels to prevent withdrawal of the wires in the opposite direction to their insertion.

Guideways 19 are formed within the body alongside each channel 17, 18 from towards the entry end for wire to beyond the location of the wedging means 15 and the slides or push-button 5 one within each guideway with its inner end abutting part of its respective wedging means 15, and its outer end protruding outwards beyond the entry end of its channel, retention means 20 being provided between each slide or push-button 5 and its guideway to assist in the retention of the slide or push-button 5 within its guideway 19 whilst allowing inward sliding to push the wedging means against its spring 16.

As is illustrated in FIG. 8, the wedging means 15 are on a respective inclined slideway 21, so that when the wedging means is moved longitudinally, either by wire as it is inserted, or the slide or push-button 5 to release its wire, the movement of the wedging means is in a plane at an angle to the axis of the channels to cause the wedging means to move laterally away from or towards the wire.

The slide or push-button 5 may be rigidly secured to its respective wedging means 15, but preferably, the connection is such as to permit a degree of articulation. Thus, as is illustrated in FIGS. 9a and 9b, and FIG. 10 each slide or push-button 5 has an integral projection 22 on which the retention means are formed, and spring-clip means 23 formed at the end of the projection, the opposed fingers of which clip behind co-operating formations 24 formed at the end of the respective wedging means 15. Such an arrangement is most effective in holding the slide or push-button to its wedging means, and additionally accommodates a transverse movement of the wedging means as it moves along its inclined slideway 21.

A further advantage of the form of construction of FIGS. 9a, 9b and 10 is that assembly of the connector or locking device is facilitated by allowing the slide or push-button to be inserted into the body 2 and be clipped in place, and the respective wedging means 15 inserted into the body from the opposite end, and urged into contact with the projection 22 to bring about a snap fit connection of the fingers 23 with the formations 24, after which the spring means 16 can be fitted, and a closure cap 25 secured in place.

Thus, when wires of different diameters are inserted through the body, there is provided the certainty that the slide or push-button remains in contact with its wedging means, and the ability for the slide or push-button to have a freedom of movement cannot arise.

1-12. (canceled)

13. A connector or locking device for wire of the type incorporating a slide or push-button to disconnect the device from a wire, characterized by an annular protrusion to one end of the connector or locking device secured to a guideway of the slide for wire at that end, to form an inlet for wire extending through the connector or locking device, the annular protrusion having an angled exposed end to provide an apex lying above and overlapping the edge of the adjacent slide or push-button, and side edges that slope downwardly to both sides of the apex.

14. A connector or locking device for wire of the type incorporating a slide or push-button to disconnect the device from a wire as in claim 13, characterized in that the protrusion is separately formed and suitably attached to the connector to surround the wire inlet to the connector.

15. A connector or locking device for wire of the type incorporating a slide or push-button to disconnect the device from a wire as in claim 13, characterized in that the protrusion is formed as an annulus integrally with a guide within the connector for the passage of wire, to emerge from the connector and have its apex overlying the edge of an adjacent slide or push-button.

16. A connector or locking device for wire of the type incorporating a slide or push-button to disconnect the device from a wire as in claim 13, characterized in that where a connector has a slide or push-button at each end, an annular protrusion is provided at each end, in association with the respective slide or push-button.

17. A connector or locking device for wire of the type incorporating a slide or push-button to disconnect the device from a wire as in claim 14, characterized in that where a connector has a slide or push-button at each end, an annular protrusion is provided at each end, in association with the respective slide or push-button.

18. A connector or locking device for wire of the type incorporating a slide or push-button to disconnect the device from a wire as in claim 15, characterized in that where a connector has a slide or push-button at each end, an annular protrusion is provided at each end, in association with the respective slide or push-button.

19. A connector or locking device for wire of the type incorporating a slide or push-button to disconnect the device from a wire as in claim 13, characterized in that the wedge is spring-loaded in a direction towards the inlet to the connector or locking device.

20. A connector or locking device for wire of the type incorporating a slide or push-button to disconnect the device from a wire as in claim 13, characterized in that connector or locking device comprises a body, two channels within the body, entry ends at opposite ends for wires, and wedging means within the body spring-urged towards the entry ends and to protrude into the channels for the purpose of gripping inserted wires and preventing their withdrawal in the opposite direction to insertion, guideways being formed within the body at least one alongside each channel from adjacent its entry end to beyond its wedging means, and slides or push-buttons being fitted one within each of the guideways each with its inner end abutting part of the respective wedging means and its outer end protruding outwards beyond the entry end of the channel, retention means being provided between each slide or push-button and its guideway to retain the slide or push-button within its guideway while allowing inward sliding to push the wedging means against a spring-urge when the outer end of the slide or push-button is pushed relative to the body, the slide or push-button and the wedging means being secured together.

21. A connector or locking device for wire of the type incorporating a slide or push-button to disconnect the device from a wire as in claim 20, characterized in that the wedging means are on an inclined slideway, such that when the wedging means is moved longitudinally either by the insertion of wire, or by the slide to release the wire, its movement is in a plane at an angle to the axis of the channels (and hence the wire), to cause the wedging mean to move laterally away from and towards the wire.

22. A connector or locking device for wire of the type incorporating a slide or push-button to disconnect the device from a wire as in claim 20, characterized in that the connection between the slide or push-button and the wedging means permits articulation between them during movement of the wedging means and slide or push-button.

23. A connector or locking device for wire of the type incorporating a slide or push-button to disconnect the device from a wire as in claim 20, characterized in that the connection is formed by a flexible integral extension on the slide or push-button attached to the adjacent end of the wedging means.

24. A connector or locking device for wire of the type incorporating a slide or push-button to disconnect the device from a wire as in claim 23, characterized in that a separately formed and flexible spring-like member is provided suitably secured to the end of the slide or push-button and the adjacent end of the wedging means.

25. A connector or locking device for wire of the type incorporating a slide or push-button to disconnect the device from a wire as in claim 23, characterized in that to enable the connector to be assembled with its slide or push-button, and the wedging means subsequently fitted, spring clip means with opposed fingers may be provided on the slide or push-button to clip behind co-operating formations on the adjacent end of the wedging means.

26. A connector or locking device for wire of the type incorporating a slide or push-button to disconnect the device from a wire as in claim 20, characterized in that the spring for the wedging means can then be inserted behind the wedging means in its channel, and the channel closed by a cap against which the spring can be compressed.

27. A connector or locking device for wire of the type incorporating a slide or push-button to disconnect the device from a wire as in claim 21, characterized in that the spring for the wedging means can then be inserted behind the wedging means in its channel, and the channel closed by a cap against which the spring can be compressed.

28. A connector or locking device for wire of the type incorporating a slide or push-button to disconnect the device from a wire as in claim 22, characterized in that the spring for the wedging means can then be inserted behind the wedging means in its channel, and the channel closed by a cap against which the spring can be compressed.

29. A connector or locking device for wire of the type incorporating a slide or push-button to disconnect the device from a wire as in claim 23, characterized in that the spring for the wedging means can then be inserted behind the wedging means in its channel, and the channel closed by a cap against which the spring can be compressed.

30. A connector or locking device for wire of the type incorporating a slide or push-button to disconnect the device from a wire as in claim 24, characterized in that the spring for the wedging means can then be inserted behind the wedging means in its channel, and the channel closed by a cap against which the spring can be compressed.

31. A connector or locking device for wire of the type incorporating a slide or push-button to disconnect the device from a wire as in claim 25, characterized in that the spring for the wedging means can then be inserted behind the wedging means in its channel, and the channel closed by a cap against which the spring can be compressed.
